(19) United States
(12) Patent Application Publication
(10) Pub. No.: US 2024/0168980 A1
(43) Pub. Date: May 23, 2024

(54) RECEPTION WORK SUPPORT SYSTEM, NON-TRANSITORY COMPUTER READABLE MEDIUM STORING PROGRAM, AND LEARNING MODEL GENERATION METHOD

(71) Applicant: FUJIFILM Business Innovation Corp., Tokyo (JP)

(72) Inventors: Shuhei Kobayakawa, Kanagawa (JP); Daichi Hayashi, Kanagawa (JP); Shoko Chiba, Kanagawa (JP)

(73) Assignee: FUJIFILM Business Innovation Corp., Tokyo (JP)

(21) Appl. No.: 18/327,884

(22) Filed: Jun. 1, 2023

(30) Foreign Application Priority Data
Nov. 22, 2022 (JP) 2022-186407

(51) Int. Cl. G06F 16/31; G06F 16/36

(52) U.S. Cl. CPC G06F 16/313; G06F 16/36

(57) ABSTRACT

A reception work support system includes: one or plural processors configured to: acquire a reception content in reception work of receiving an inquiry; predict a work result based on the reception content, and extract a keyword used for predicting the work result; and emphasize and output the keyword in the reception content, or output the keyword separately from the reception content.

### CROSS-REFERENCE TO RELATED APPLICATIONS

This application is based on and claims priority under 35 USC 119 from Japanese Patent Application No. 2022-186407 filed Nov. 22, 2022.

### BACKGROUND

### (i) Technical Field

The present invention relates to a reception work support system, a non-transitory computer readable medium storing a program, and a learning model generation method.

### (ii) Related Art

In JP2006-285212A, there is described a program for causing a computer to function as an operator work support system that improves, in a case where a call content is recorded and voice recognition is performed, and is converted into text data and displayed on a screen in an operator work, operation efficiency of an operator by highlighting a keyword designated in advance.

In JP2012-123455A, there is described a summarization apparatus including a sentence importance degree estimator that stores weights of feature quantities of sentences learned in advance as a set of parameters, a sentence importance degree estimation unit that obtains an importance degree weight (Uᵢ) of each sentence of a document by using the sentence importance degree estimator (where Uᵢ represents the i-th sentence of the document), and a summarization processing unit that creates a summary by obtaining zᵢⱼ which maximizes a sum of products of mᵢⱼ, wᵢⱼ, and zᵢⱼ for all available i and j from the document when mᵢⱼ is set to be a binary value representing whether or not the i-th sentence of the document includes the word j, wᵢⱼ is set to be a weight of the word j in the i-th sentence, and zᵢⱼ is set to be a binary value representing whether or not the word j in the i-th sentence is included in the summary. The summarization processing unit obtains wᵢⱼ such that a value is increased as weight (Uᵢ) is increased and the value is increased as the importance degree weight (wⱼ) of the word j (where wⱼ represents the j-th word in a vocabulary constituting the document) is increased. Therefore, an importance degree of a word included in a sentence clearly having a low importance degree from a context is reduced, and accuracy of automatic summarization is improved.

### SUMMARY

In an operator work for receiving an inquiry from a customer, such as responding to a telephone call for a failure repair request, a system that voice-recognizes contents of a dialogue and displays the contents on a screen of an operator to support a response or a record input is often used. Meanwhile, in a case where the call becomes long, it is not possible to specify a key-portion included in the voice recognition result, and it is difficult to utilize the call. Although there is a technology for automatically summarizing sentences, it is not possible to correctly extract key-portions since keywords or key-contents differ depending on a specific work content, and as a result, an operation time or an operation load cannot be reduced as compared to before the technology introduction.

Aspects of non-limiting embodiments of the present disclosure relate to a reception work support system, a non-transitory computer readable medium storing a program, and a learning model generation method that extract and emphasize a keyword or a key-content according to a work content obtained by receiving an inquiry, in reception work of receiving the inquiry.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a reception work support system including: one or a plurality of processors configured to: acquire a reception content in reception work of receiving an inquiry; predict a work result based on the reception content, and extract a keyword used for predicting the work result; and emphasize and output the keyword in the reception content, or output the keyword separately from the reception content.

### BRIEF DESCRIPTION OF THE DRAWINGS

Exemplary embodiment(s) of the present invention will be described in detail based on the following figures, wherein:

FIG. 1 is a diagram illustrating a configuration of a reception work support system according to the present exemplary embodiment;

FIG. 2 is a diagram illustrating a hardware configuration example of a computer used as a management server and an operator terminal according to the present exemplary embodiment;

FIG. 3 is a diagram illustrating a functional configuration of the management server according to the present exemplary embodiment;

FIG. 4 is a diagram illustrating a functional configuration of the operator terminal according to the present exemplary embodiment;

FIG. 5 is a diagram illustrating a flow of processes at a time of receiving an inquiry according to the present exemplary embodiment;

FIG. 6 is a diagram illustrating a flow of generation of a learning model according to the present exemplary embodiment;

FIG. 7 is a diagram illustrating an example of the learning model;

FIGS. 8A and 8B are diagrams illustrating an example in which a keyword extracted for each work result is displayed separately from each other in a case where there are a plurality of work results, FIG. 8A is a diagram illustrating an example of displaying the keyword conspicuously from text information of reception contents, and FIG. 8B is a diagram illustrating an example of displaying the keyword separately from the text information of the reception contents;

FIG. 9 is a diagram illustrating a flow of processes at a time of receiving an inquiry according to a modification example; and

FIG. 10 is a diagram illustrating a flow of creating a dictionary related to a keyword in predicting a work result from the reception contents according to the modification example.

### DETAILED DESCRIPTION

Hereinafter, the present exemplary embodiments will be described in detail with reference to drawings.

Configuration of Reception Work Support System

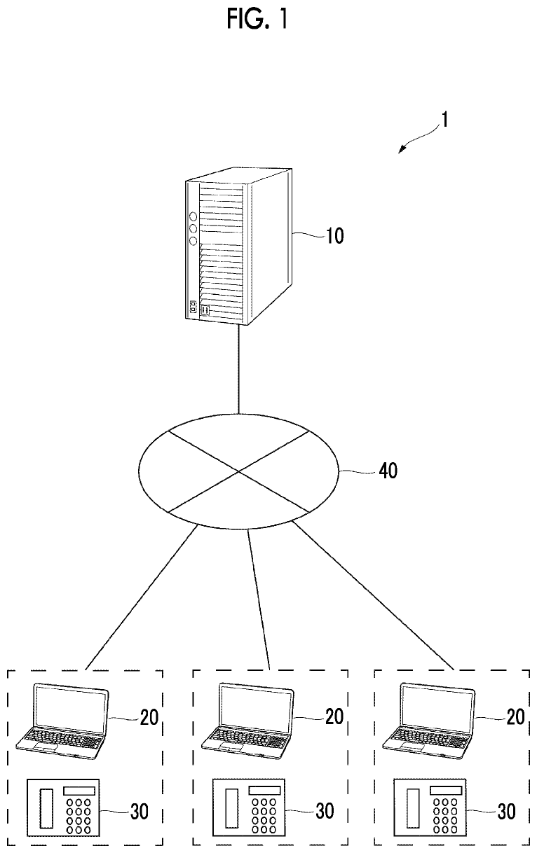

FIG. 1 is a diagram illustrating a configuration of a reception work support system according to the present exemplary embodiment.

A reception work support system 1 according to the present exemplary embodiment is a system that extracts, in an operator work of receiving an inquiry from a customer, a keyword from received contents, and emphasizes and outputs the keyword.

The reception work support system 1 includes a management server 10, an operator terminal 20, and a telephone 30. The management server 10, the operator terminal 20, and the telephone 30 are connected to each other via a network 40.

The management server 10 is a server that manages the reception contents in the operator work of receiving the inquiry from the customer, and history information related to a work result for the reception contents. In addition, the management server 10 is trained by associating the reception content with the work result of the reception content. The management server 10 extracts a keyword to be used in predicting the work result from the reception contents based on a learning result as the keyword in the reception contents, and generates a learning model for predicting the keyword from the reception contents. The management server 10 is realized by, for example, a computer. The management server 10 may be configured by a single computer, or may be realized by a distribution process by a plurality of computers.

The operator terminal 20 and the telephone 30 are an information processing apparatus and a telephone used by an operator in the operator work of receiving the inquiry from the customer. Contents of a call made by the telephone 30 are analyzed by the operator terminal 20, and converted into text information. The operator terminal 20 connects to the management server 10 via the network 40.

The operator terminal 20 is realized by, for example, a computer, a tablet-type information terminal, or another information processing apparatus.

The network 40 is an information communication network that is responsible for communication between the management server 10 and the operator terminal 20. A type of the network 40 is not particularly limited as long as data can be transmitted and received, and may be, for example, the Internet, a local area network (LAN), a wide area network (WAN), or the like. A communication line used for data communication may be wired or wireless. In addition, each apparatus may be configured to be connected via a plurality of networks or communication lines.

Hardware Configuration of Computer

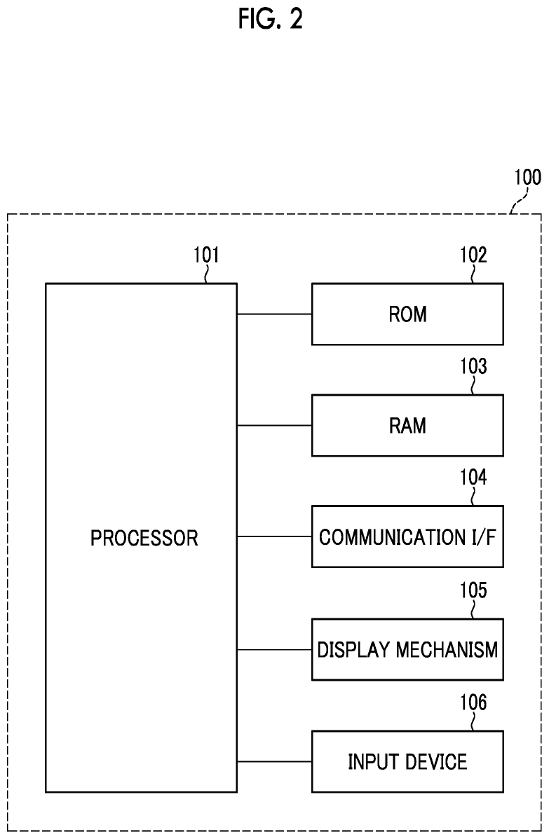

FIG. 2 is a diagram illustrating a hardware configuration example of a computer 100 used as the management server 10 and the operator terminal 20. The computer 100 includes a processor 101, a read only memory (ROM) 102, and a random access memory (RAM) 103. The processor 101 is, for example, a central processing unit (CPU), and uses the RAM 103 as an operation area to execute a program read from the ROM 102. Further, the computer 100 includes a communication interface 104 for connecting to a network and a display mechanism 105 for performing a display output on a display. In addition, the computer 100 includes an input device 106 with which an input operation is performed by an operator of the computer 100. The configuration of the computer 100 illustrated in FIG. 2 is only an example, and the computer used in the present exemplary embodiment is not limited to the configuration example in FIG. 2.

The various processes to be executed in the present exemplary embodiment are executed by one or a plurality of processors.

Functional Configuration of Management Server

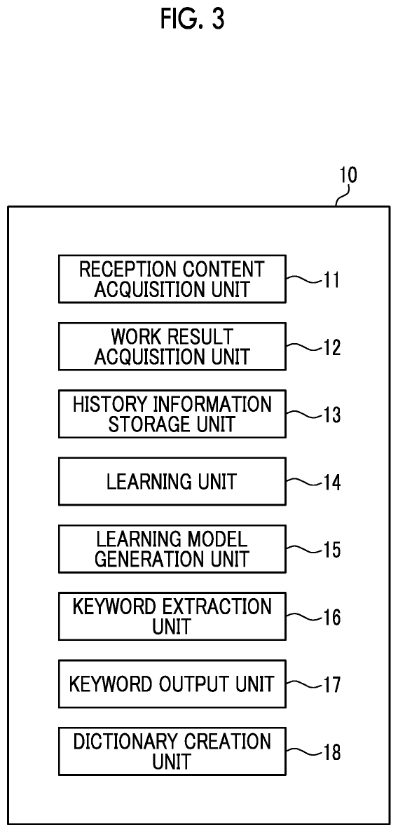

Next, a functional configuration of the management server 10 will be described with reference to FIG. 3. FIG. 3 is a diagram illustrating a functional configuration of the management server 10 according to the present exemplary embodiment.

As illustrated in FIG. 3, the management server 10 includes a reception content acquisition unit 11 that acquires a reception content in an operator work, a work result acquisition unit 12 that acquires a work result for the reception content, and a history information storage unit 13 that stores a history of the acquired reception content and work result. In addition, the management server 10 includes a learning unit 14 that performs learning by associating the reception content and the work result of the reception content, and a learning model generation unit 15 that generates a learning model that predicts a work result from the reception content based on a learning result. Further, the management server 10 includes a keyword extraction unit 16 that extracts a keyword to be used in the prediction, and a keyword output unit 17 that emphasizes and outputs the extracted keyword. Further, the management server 10 includes a dictionary creation unit 18 that creates a dictionary related to the keyword. A function of the dictionary creation unit 18 and an exemplary embodiment using the dictionary creation unit 18 will be described in a modification example which will be described below.

In a case where the management server 10 illustrated in FIG. 3 is realized by the computer 100 illustrated in FIG. 2, each function of the reception content acquisition unit 11, the work result acquisition unit 12, and the keyword output unit 17 is realized by, for example, the communication interface 104. The history information storage unit 13 is realized by, for example, the ROM 102. Each function of the learning unit 14, the learning model generation unit 15, the keyword extraction unit 16, and the dictionary creation unit 18 is realized, for example, by the processor 101 executing a program.

Functional Configuration of Operator Terminal

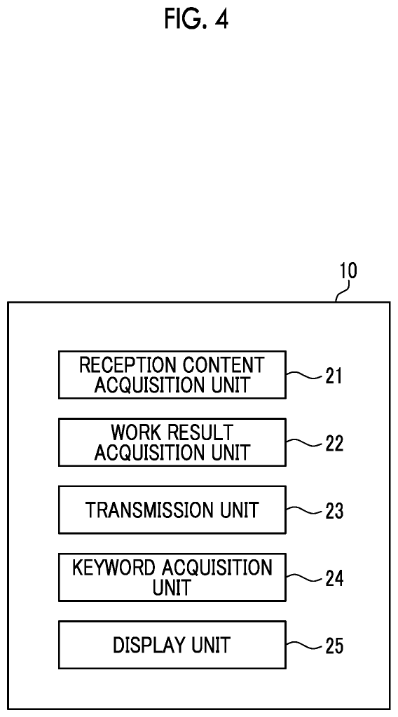

FIG. 4 is a diagram illustrating a functional configuration of the operator terminal 20 according to the present exemplary embodiment. As illustrated in FIG. 4, the operator terminal 20 includes a reception content acquisition unit 21 that acquires a reception content in an operator work, a work result acquisition unit 22 that acquires a work result for the reception content, and a transmission unit 23 that transmits the acquired reception content and work result to the management server 10. Further, the operator terminal 20 includes a keyword acquisition unit 24 that acquires a keyword in the reception content, and a display unit 25 that highlights the acquired keyword.

The reception content acquisition unit 21 acquires voice data of an inquiry by a telephone, and acquires the reception content as text information by voice recognition. A format of the inquiry is not limited to the telephone, and may be a text inquiry such as an inquiry by an e-mail. In this case, the reception content acquisition unit 21 acquires text information of the inquiry.

In a case where the operator terminal 20 illustrated in FIG. 4 is realized by the computer 100 illustrated in FIG. 2, each function of the reception content acquisition unit 21, the work result acquisition unit 22, the transmission unit 23, and the keyword acquisition unit 24 is realized by, for example, the communication interface 104. The display unit 25 is realized by, for example, the display mechanism 105.

Process at Time of Receiving Inquiry

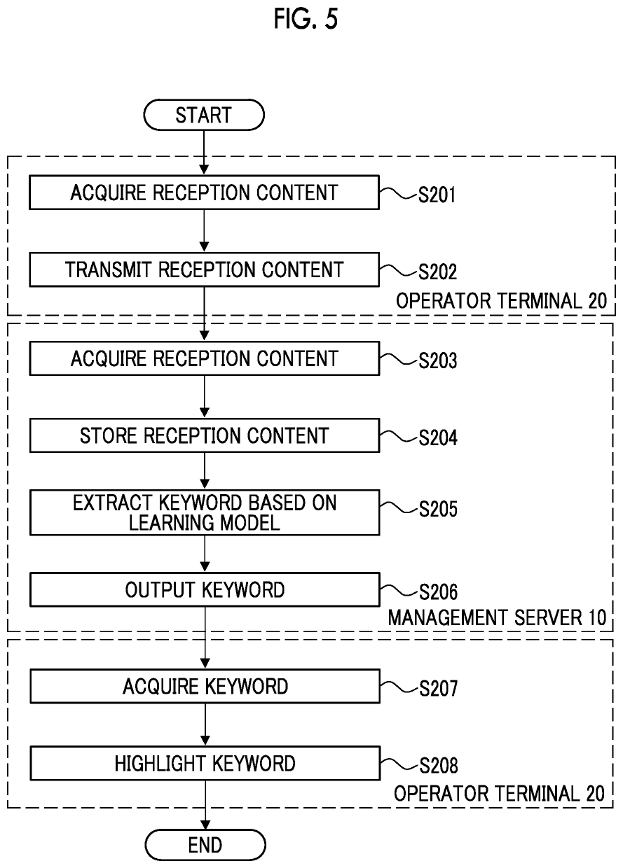

Next, a flow of processes at a time of receiving an inquiry will be described with reference to FIG. 5. FIG. 5 is a flowchart illustrating a flow of processes at a time of receiving an inquiry according to the present exemplary embodiment.

In FIG. 5, first, in a case where there is an inquiry from a customer, the reception content acquisition unit 21 of the operator terminal 20 acquires a reception content (step S201). In a case of the inquiry by voice such as a telephone, the reception content acquisition unit 21 converts voice information into text information, and acquires the inquiry. The text information may be created for an entire call voice, or may be created separately for a speech part of an operator and a speech part of the customer. In a case of an inquiry by a text such as an e-mail, text information is acquired as the reception content.

Subsequently, the reception content acquired by the reception content acquisition unit 21 is transmitted to the management server 10 by the transmission unit 23 of the operator terminal 20 (step S202), and the reception content acquisition unit 11 of the management server 10 acquires the reception content (step S203). The reception content acquired by the reception content acquisition unit 11 is stored in the history information storage unit 13 of the management server 10 (step S204).

Subsequently, the keyword extraction unit 16 of the management server 10 extracts a keyword to be used in prediction from the acquired reception content as a keyword in reception contents based on a learning model (step S205). Details of generation of the learning model used in step S205 and a process at the time of learning will be described below.

Subsequently, the keyword output unit 17 of the management server 10 outputs the keyword extracted by the keyword extraction unit 16 (step S206). In a case where there are a plurality of work results, the management server 10 may extract a keyword by using a learning model different for each work result, and output the keyword. Details of types of work results will be described below.

Subsequently, the keyword acquisition unit 24 of the operator terminal 20 acquires the keyword in the reception content (step S207), and the acquired keyword is highlighted on the display unit 25 of the operator terminal 20 (step S208). A highlighting method will be described in detail below.

In the flow of the processes at the time of receiving the inquiry illustrated in FIG. 5, an example of extracting the keyword from the reception content by using the generated learning model, and outputting the keyword is described. Meanwhile, the exemplary embodiment is not limited to this example. There may be provided a configuration in which each time a reception content is input, a work result is predicted from the reception content, and a phrase used for predicting the work result is extracted as a keyword in the reception content and output. In addition, although the work result is predicted, the keyword may be extracted from the reception content by using the created learning model and output.

Generation of Learning Model

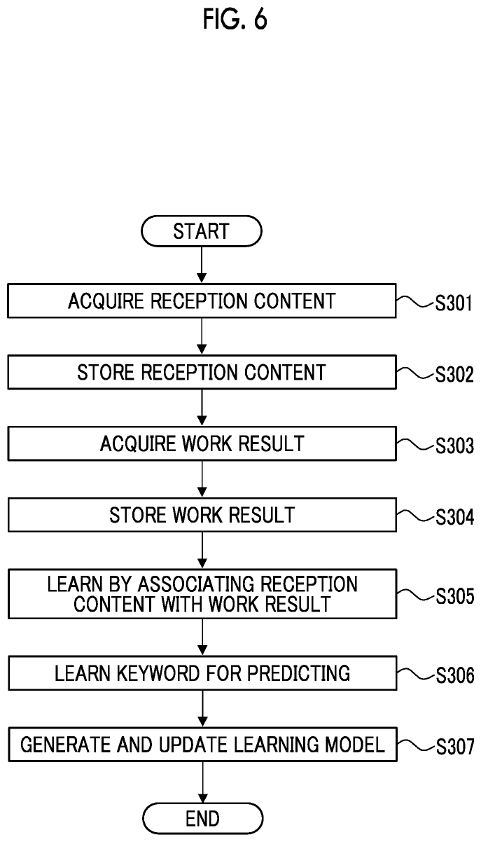

Next, generation of a learning model will be described with reference to FIG. 6. FIG. 6 is a flowchart illustrating a flow of generation of a learning model according to the present exemplary embodiment.

The learning unit 14 is trained by associating a reception content with a work result of the reception content stored in the history information storage unit 13, and learns a phrase used in predicting the work result from the reception content as a keyword in the reception content. The learning model generation unit 15 generates a learning model that predicts a keyword from a reception content based on a result of learning by the learning unit 14.

In FIG. 6, first, the reception content acquisition unit 11 of the management server 10 acquires a reception content (step S301). The reception content acquired by the reception content acquisition unit 11 is stored in the history information storage unit 13 of the management server 10 (step S302).

Subsequently, the work result acquisition unit 12 of the management server 10 acquires a work result (step S303). The work result acquired by the work result acquisition unit 12 is stored in the history information storage unit 13 of the management server 10 (step S304).

The work result acquisition unit 12 may acquire a work result from the operator terminal 20 in step S303, or may acquire an input of the work result from an external apparatus other than the operator terminal 20. For example, the work result acquisition unit 12 may acquire a work result in a department in charge to which an operator who receives an inquiry transfers the inquiry, from a terminal in which the work result is input from the department in charge. The department in charge is, for example, a department having more specialized knowledge about contents of the inquiry, such as a “software division”, and keywords in a specialized field may be extracted by using work results of the department in charge.

In addition, in step S303, the work result acquisition unit 12 may acquire, for example, a measure result of an engineer who receives a home-visit request in a failure repair request as the work result.

In addition, the reception content and the work result acquired by the management server 10 may be records collected in advance by an external apparatus. That is, the management server 10 may acquire the reception content and the work result from the external apparatus in which the past reception content and the corresponding work result are recorded.

Subsequently, the learning unit 14 of the management server 10 performs learning by associating the reception content with the work result of the reception content stored in the history information storage unit 13 (step S305). The learning unit 14 learns a key-phrase for predicting the work result from the reception content (step S306), and the learning model generation unit 15 of the management server 10 generates or updates a learning model for predicting the keyword from the reception content (step S307).

In step S305, there may be provided a configuration in which in a case where there are a plurality of work results, the learning unit 14 performs learning by associating the reception content and the work result for each work result, and generates a learning model that predicts a keyword for each work result from the reception content. By separating the learning models, a key-phrase for each learning model is changed even in a case where the reception contents are the same, so that a keyword for each work result can be output.

Process at Learning

Next, an example of processes in steps S305 to S307 in FIG. 6 by the learning unit 14 and the learning model generation unit 15 will be described.

The learning model generation unit 15 generates a learning model that outputs a keyword to be used in predicting a work result from a reception content based on a learning result of the learning unit 14. The functions of the learning unit 14 and the learning model generation unit 15 are realized, for example, by the processor 101 of the computer 100 executing a machine learning program.

The machine learning program is a program for machine-learning a relationship in which a reception content is input and a keyword of the reception content is output.

In the machine learning program, for example, first, a prediction model is created to which a reception content is input and from which a work result for the reception content is output. In the machine learning program, in a case where the reception content and the work result are given as teacher data, for example, a variable in each layer constituting the learning model is adjusted based on the teacher data. In a case where information on the reception content is given as an input, the learning proceeds such that the work result for the reception content is output.

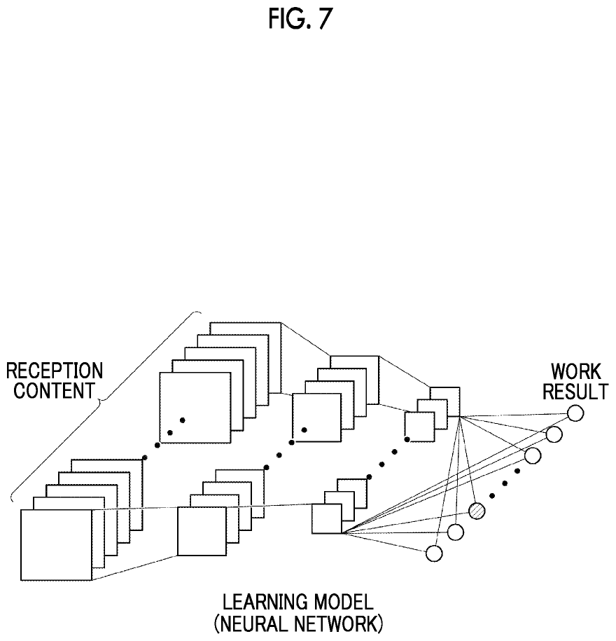

FIG. 7 is a diagram illustrating an example of a learning model. In FIG. 7, a neural network is illustrated as an example of the learning model.

The neural network is configured with an input layer, an output layer, and hidden layers between the input layer and the output layer. In the network, learning proceeds in a mode of adjusting internal parameters to reproduce a relationship between input data and output data.

In the prediction model to which a reception content is input and from which a work result for the reception content is output, for example, a probability in which a plurality of work results held as candidates are correct answers is calculated respectively. Among the work results, a work result having a predetermined threshold value or more is output, or a predetermined number of work results having high probabilities are output from a top.

In the example illustrated in FIG. 7, one or a plurality of work results among the work results held as the candidates are output in response to the input of the reception content.

Subsequently, a machine learning program extracts a keyword for prediction in the created prediction model. For example, the machine learning program searches for a phrase having a high importance degree of which a probability of occurrence of a work result is changed depending on whether or not a specific phrase is included in the reception content, and a phrase having a low importance degree that does not affect predicting the work result, whether or not the phrase is included in the reception content.

For example, since a phrase such as “hi” or “hello” is not associated with the work result, it is determined that the phrase does not affect the prediction of the work result, and has a low importance degree. On the other hand, for example, in an inquiry about a failure repair request for an image forming apparatus, in a case where a phrase “a line is included” is included, a probability of occurrence of a work result “corrected by replacing a specific part” is increased. In this case, it is determined that “a line is included” is a phrase of a high importance degree that affects the probability of occurrence of the work result.

In this manner, the machine learning program extracts a phrase that affects an occurrence probability of the work result as a keyword, and learns the phrase as the keyword in the reception content. By determining an importance degree of the phrase included in the reception content in this manner, the learning model that outputs the keyword from the reception content is generated.

The generation of this learning model is executed, for example, by using the neural network illustrated in FIG. 7. The learning model is generated in which the reception content is input and the keyword in the reception content is output.

The machine learning program acquires the reception content and the keyword in the reception content as teacher data, and adjusts a variable of each layer constituting the learning model based on the teacher data. In a case where information on the reception content is given as the input, learning proceeds such that the keyword in the reception content is output.

Although an example in which the learning model that outputs the keyword is generated from the reception content is described here, the process in the learning unit described above is merely an example. The process in the learning unit according to the present exemplary embodiment is not limited to the configuration example described above. For example, there may be provided a configuration in which each time a reception content is input, a work result is predicted from the reception content, and a phrase used for predicting the work result is extracted as a keyword in the reception content and output.

Type of Work Result

Next, a type of work result will be described by using an example of inquiring about a failure repair request by a telephone.

A work result for inquiring about a failure repair request by a telephone include a work result input by an operator who receives the inquiry and a work result input from a department in charge to which the operator who receives the inquiry transfers the inquiry. In addition, in a case where a home-visit repair by an engineer is required, a measure result by the engineer is also used as the work result.

The work result input by the operator who receives the inquiry includes a work result related to a work flow and a work result related to a failure content.

The work result related to the work flow is a result of who handles and how. The work result related to the failure content is a failure content determined from the inquiry content.

For example, the work result related to the work flow includes “telephone resolution” indicating that the problem is resolved by a telephone, “engineer dispatch” indicating that the engineer is dispatched without resolving the problem by a telephone, and the like. More specifically, information such as “transfer to software division” and “transfer to consumable purchase division” can also be used as the work result.

The work result related to the failure content includes a work result indicating what kind of failure occurs, for example, in a case of a printer failure repair request, such as “image quality failure”, “paper jam”, “abnormal sound”, “defective”, “FAX transmission and reception”, “use method inquiry”, and the like.

The work result input from the department in charge to which the operator who receives the inquiry transfers the inquiry has the same manner as the work result input by the operator who receives the inquiry. Meanwhile, a measure made from a more specialized perspective is input as the work result.

A case where a measure result of an engineer who performs a home-visit repair is used as the work result includes a case where a record of repair contents described by the engineer is used as the work result and a case where parts used for the repair is used as the work result.

The case where the record of the repair contents described by the engineer is used as the work result includes a case where a record of failure contents is used and a case where a record of a measure result is used. The record of the failure contents is a record indicating what kind of failure occurs, in the same manner as the work result related to the failure contents input by the operator who receives the inquiry.

The record of the measure result is a record indicating what kind of treatment is taken for a failure, such as “component replacement”, “cleaning”, “polishing”, “lubrication”, “setting adjustment”, “emergency treatment”, and “irregular setting”.

In a case where the parts used for the repair are used as the work result, names of the used parts such as “photoreceptor”, “developing device”, “transfer roll”, “fixing machine”, and “manual feed tray” are used as the work result.

The type of work result described above is an example, and the work result according to the present exemplary embodiment is not limited to the format described above.

Display Method

Next, an example of highlighting in step S208 in FIG. 5 will be described.

As a method of highlighting a keyword in the display unit 25, there are a method of displaying the keyword conspicuously in text information of reception contents and a method of displaying the keyword separately from the text information of the reception contents.

As the method of conspicuously displaying the keyword in the text information of the reception contents, there is a method of displaying the keyword in a different font format from other information. For example, the keyword is displayed in bold or in a different color to conspicuously display the keyword.

As the method of displaying the keyword separately from the text information of the reception contents, there is a method of displaying a list of the keyword.

These display methods may be configured to be switched as needed. For example, in a case where it is required to know where the key-portion is while grasping the whole conversation, the keyword may be conspicuously displayed in the text information, and in a case where it is required to know all the phrases listed as the keyword, the keywords may be displayed separately from the text information.

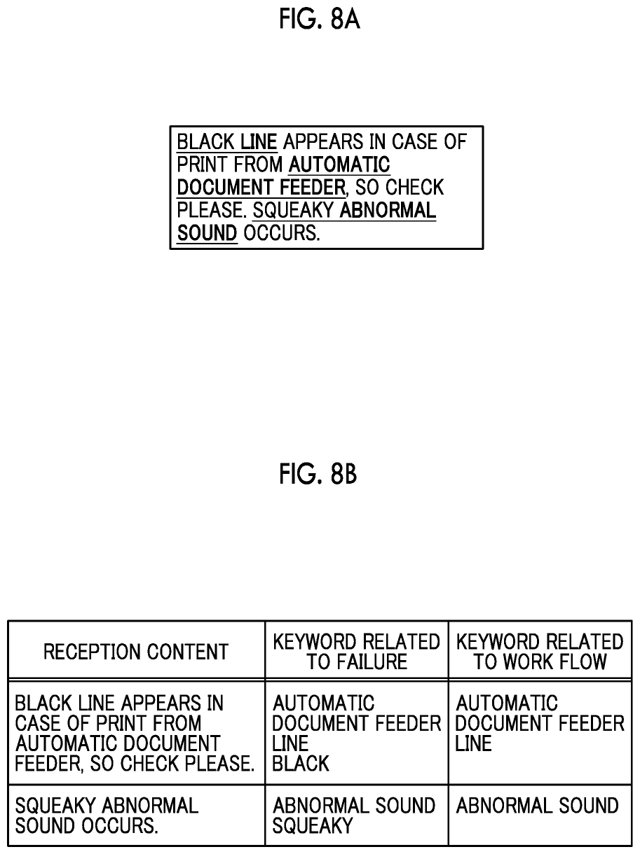

Further, in a case where there are a plurality of work results, a keyword extracted for each work result may be displayed separately from each other. An example in which the keyword extracted for each work result is displayed separately from each other will be described with reference to FIGS. 8A and 8B.

FIGS. 8A and 8B are diagrams illustrating an example in which a keyword extracted for each work result is displayed separately from each other in a case where there are a plurality of work results, FIG. 8A is a diagram illustrating an example of displaying the keyword conspicuously from text information of reception contents, and FIG. 8B is a diagram illustrating an example of displaying the keyword separately from the text information of the reception contents.

In a case where a keyword is displayed in a different font format from other information, by changing the font of the keyword for each work result, it is possible to recognize which work result the keyword belongs to. For example, as illustrated in FIG. 8A, keywords related to a failure are underlined, and keywords related to a work flow are displayed in bold, so that it is possible to recognize which work result the keyword belongs to.

In addition, in a case of displaying a list of keywords, by displaying the keywords collectively for each work result as illustrated in FIG. 8B, it is possible to recognize which work result the keyword belongs to.

Further, a display order of keywords may be configured to be switched as needed. For example, in a case where it is required to check as a memo during a dialogue, the keywords may be configured to be displayed in chronological order. In a case where it is required to create a summary after the dialogue, the keywords may be configured to be displayed in order of importance degree. In this manner, the display order may be switched by pull-down selection or the like according to the application.

An operator who receives an inquiry can determine a measure based on the keyword in reception contents displayed on the display unit 25. For example, in a case where the inquiry is an inquiry about a failure repair request by a telephone, the operator can perform a determination based on the keyword displayed on the display unit 25, for a manner such as whether a problem can be resolved by the telephone and what instruction is to be given in a case where the problem can be resolved by the telephone.

In addition, the display unit 25 of the operator terminal 20 may highlight the keyword in the reception contents, or may display the keyword separately from the reception contents. Therefore, it is possible to assist or automate a work of creating a summary of the reception contents or a work of creating a reception memo.

Further, in a case where there are a plurality of work results, the display unit 25 of the operator terminal 20 may display the keyword extracted for each work result separately from each other. Therefore, for example, in a case where a work flow is to be determined, it becomes easier to grasp a keyword needed for a determination, such as focusing on the keyword related to the work flow.

In the present exemplary embodiment, the management server 10 outputs a phrase to be used in predicting a work result from reception contents as a keyword in the reception contents. Therefore, keywords or key-contents may be extracted according to work contents.

### Modification Example

Subsequently, a modification example according to the present exemplary embodiment will be described.

In the modification example, the management server 10 creates a dictionary related to a keyword by using the dictionary creation unit 18, instead of generating a learning model by the learning model generation unit 15. At a time of receiving an inquiry, the management server 10 extracts a keyword based on the created dictionary, and outputs the keyword.

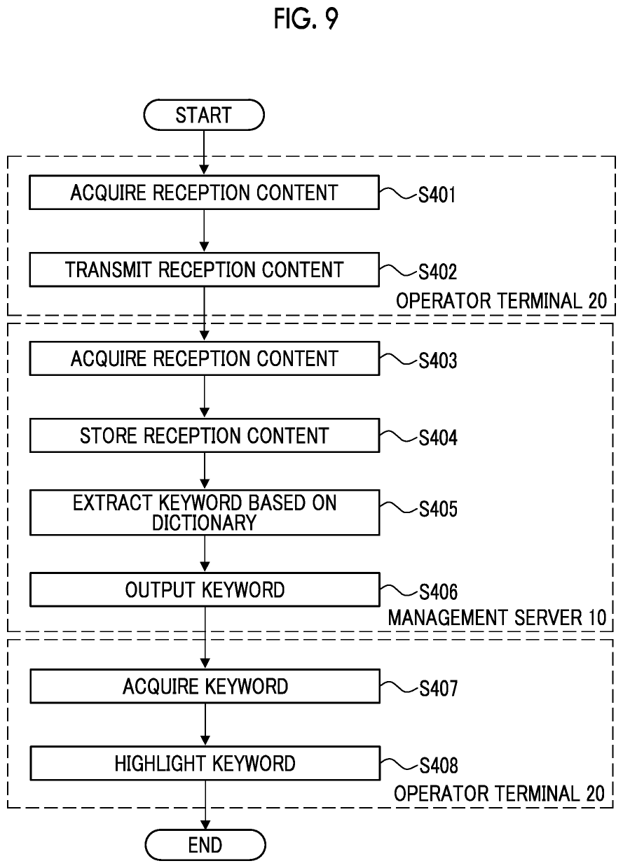

FIG. 9 is a flowchart illustrating a flow of processes at a time of receiving an inquiry according to the modification example.

In FIG. 9, processes in steps S401 to S404 and steps S406 to S408 are executed in the same manner as the processes in steps S201 to S204 and steps S206 to S208 in FIG. 5.

Following the process in step S404, the keyword extraction unit 16 of the management server 10 extracts a keyword based on a dictionary (step S405). For example, in a case where a phrase registered in the dictionary is included in the reception content, the keyword extraction unit 16 extracts the phrase as a keyword in the reception content. Details of generation of the dictionary used in step S405 will be described below.

A method of highlighting the keyword on the display unit 25 of the operator terminal 20 has the same manner as the method in step S208 in FIG. 5.

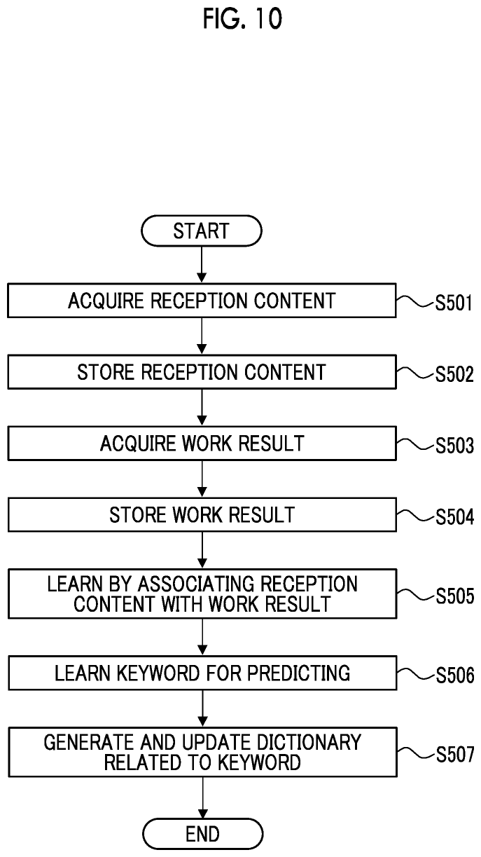

Next, the creation of the dictionary will be described with reference to FIG. 10. FIG. 10 is a flowchart illustrating a flow of creating a dictionary for a keyword according to the modification example.

In FIG. 10, processes in steps S501 to S506 are executed in the same manner as the processes in steps S301 to S306 in FIG. 6.

Following the process of step S506, the dictionary creation unit 18 of the management server 10 creates or updates a dictionary related to a keyword based on a result of learning by the learning unit 14 (step S507).

The learning by the learning unit 14 is executed, for example, by using the neural network illustrated in FIG. 7. In step S505, the learning unit 14 creates, for example, a prediction model to which the reception content is input and from which a work result for the reception content is output. Further, in step S506, the learning unit 14 searches for a phrase having a high importance degree of which an occurrence probability of the work result is changed depending on whether or not a specific phrase is included in the reception content, and extracts a predictive keyword.

The dictionary creation unit 18 collects the extracted predictive keywords as a keyword in the reception content, and creates or updates a dictionary related to the keyword.

For example, in a case where there are a plurality of work results, the dictionary related to the keyword in the reception content may be created for each work result. The phrase determined to have a high importance degree in the reception content at the time of learning by the learning unit 14 is collected for each work result and registered in the dictionary.

The created dictionary is used to extract a keyword from a reception content in a case where an inquiry is received. In a case of acquiring the reception content, for example, the management server 10 searches for a keyword registered in the dictionary from the reception content, and emphasizes and outputs the keyword.

Although the present exemplary embodiments and modification example are described above, a technical scope of the exemplary embodiments of the present invention is not limited to the scope described in the exemplary embodiments described above. Various modifications or improvements are added to the exemplary embodiments described above within the technical scope of the exemplary embodiments of the present invention.

Supplementary Note

(((1)))

A reception work support system comprising:
one or a plurality of processors configured to:
   acquire a reception content in reception work of receiving an inquiry;
   predict a work result based on the reception content, and extract a keyword used for predicting the work result; and
   emphasize and output the keyword in the reception content, or output the keyword separately from the reception content.

(((2)))

The reception work support system according to (((1))), wherein the one or plurality of processors are configured to:
in a case where there are a plurality of work results, extract the keyword by using a learning model that is different for each work result.

(((3)))

The reception work support system according to (((1))) or (((2))), wherein the one or plurality of processors are configured to:
in a case where there are a plurality of work results, output the keyword extracted for each work result separately from each other.

(((4)))

The reception work support system according to any one of (((1))) to (((3))), wherein the one or plurality of processors are configured to:
switch a display order of the keyword and output the keyword.

(((5)))

The reception work support system according to (((1))), wherein the one or plurality of processors are configured to:
in a case where the reception content is voice information, convert the voice information into text information, and
highlight and output the keyword in the converted text information.

(((6)))

The reception work support system according to (((5))), wherein the one or plurality of processors are configured to:
display and output the keyword in a different font format from other information, in the text information.

(((7)))

The reception work support system according to (((5))), wherein the one or plurality of processors are configured to:
perform a display output of the keyword separately from the display output of the text information.

(((8)))

A non-transitory computer readable medium storing a program causing one or a plurality of processors to realize a function comprising:
acquiring a reception content in reception work of receiving an inquiry;
predicting a work result based on the reception content, and extracting a keyword used for predicting the work result; and
creating a dictionary related to a key-phrase in the reception content based on the extracted keyword.

(((9)))

A learning model generation method comprising:
acquiring a reception content in reception work of receiving an inquiry and a work result performed for the reception content as teacher data; and
generating a learning model that predicts the work result based on the reception content for an input of the reception content, and extracts a keyword used for predicting the work result, by using the teacher data.

(((10)))

The learning model generation method according to (((9))),
wherein the teacher data includes a work result in a process other than the reception work.

(((11)))

The learning model generation method according to (((10))),
wherein the work result in the process other than the reception work is a work result of a department in charge to which the reception work is transferred.

(((12)))

A non-transitory computer readable medium storing a program causing one or a plurality of processors to realize a function comprising:
acquiring a reception content in reception work of receiving an inquiry;
predicting a work result based on the reception content, and extracting a keyword used for predicting the work result; and
emphasizing and outputting the keyword in the reception content, or outputting the keyword separately from the reception content.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A reception work support system comprising:
one or a plurality of processors configured to:
acquire a reception content in reception work of receiving an inquiry;
predict a work result based on the reception content, and extract a keyword used for predicting the work result; and
emphasize and output the keyword in the reception content, or output the keyword separately from the reception content.

2. The reception work support system according to claim 1, wherein the one or plurality of processors are configured to:
in a case where there are a plurality of work results, extract the keyword by using a learning model that is different for each work result.

3. The reception work support system according to claim 1, wherein the one or plurality of processors are configured to:
in a case where there are a plurality of work results, output the keyword extracted for each work result separately from each other.

4. The reception work support system according to claim 2, wherein the one or plurality of processors are configured to:
in a case where there are a plurality of work results, output the keyword extracted for each work result separately from each other.

5. The reception work support system according to claim 1, wherein the one or plurality of processors are configured to:
switch a display order of the keyword and output the keyword.

6. The reception work support system according to claim 2, wherein the one or plurality of processors are configured to:
switch a display order of the keyword and output the keyword.

7. The reception work support system according to claim 3, wherein the one or plurality of processors are configured to:
switch a display order of the keyword and output the keyword.

8. The reception work support system according to claim 4, wherein the one or plurality of processors are configured to:
switch a display order of the keyword and output the keyword.

9. The reception work support system according to claim 1, wherein the one or plurality of processors are configured to:
in a case where the reception content is voice information, convert the voice information into text information, and
highlight and output the keyword in the converted text information.

10. The reception work support system according to claim 9, wherein the one or plurality of processors are configured to:
display and output the keyword in a different font format from other information, in the text information.

11. The reception work support system according to claim 9, wherein the one or plurality of processors are configured to:
perform a display output of the keyword separately from the display output of the text information.

12. A non-transitory computer readable medium storing a program causing one or a plurality of processors to realize a function comprising:
acquiring a reception content in reception work of receiving an inquiry;
predicting a work result based on the reception content, and extracting a keyword used for predicting the work result; and
creating a dictionary related to a key-phrase in the reception content based on the extracted keyword.

13. A learning model generation method comprising:
acquiring a reception content in reception work of receiving an inquiry and a work result performed for the reception content as teacher data; and
generating a learning model that predicts the work result based on the reception content for an input of the reception content, and extracts a keyword used for predicting the work result, by using the teacher data.

14. The learning model generation method according to claim 13,
wherein the teacher data includes a work result in a process other than the reception work.

15. The learning model generation method according to claim 14,
wherein the work result in the process other than the reception work is a work result of a department in charge to which the reception work is transferred.

16. A non-transitory computer readable medium storing a program causing one or a plurality of processors to realize a function comprising:
acquiring a reception content in reception work of receiving an inquiry;
predicting a work result based on the reception content, and extracting a keyword used for predicting the work result; and
emphasizing and outputting the keyword in the reception content, or outputting the keyword separately from the reception content.
